(19) United States
(12) Patent Application Publication
(10) Pub. No.: US 2007/0137507 A1
(43) Pub. Date: Jun. 21, 2007

(54) Novel means of delivery of fountain solutions for printing

(75) Inventor: Krishnan Ramasamy, Colonia, NJ (US)

Correspondence Address: Kurt G. Briscoe;Norris, McLaughlin & Marcus P.A., 18th Floor, 875 Third Avenue, New York, NY, 10022, US

(73) Assignee: Sun Chemical Corporation, Parsippany, NJ (US)

(21) Appl. No.: 11/314,992

(22) Filed: Dec. 21, 2005

(51) Int. Cl. B41N 3/08

(52) U.S. Cl. 101/350.1

(57) ABSTRACT

A fountain solution kit comprising: (a) a first water-soluble pouch which contains solid materials suitable for a fountain solution; (b) a second water-soluble pouch which contains a liquid; and, optionally, (c) a third water-soluble pouch which contains the first and second water-soluble pouches. Also disclosed is a method of delivering a fountain solution to a printing press which comprises mixing the water-soluble pouches from the fountain solution kit into water to form the fountain solution and transferring the fountain solution formed to the printing press. It is emphasized that this abstract is provided to comply with the rules requiring an abstract which will allow a searcher or other reader quickly to ascertain the subject matter of the technical disclosure. It is submitted with the understanding that it will not be used to interpret or limit the scope or meaning of the appended issued claims.

### BACKGROUND OF THE INVENTION

1. Field of the Invention

The present invention relates to fountain solution kits and the use thereof in delivering fountain solutions to a printing press.

2. Description of Related Art

The use of dampening solutions, also known as fountain solutions, is a standard practice in offset printing. It keeps the non-image area of the print clean and free from ink and helps to cool the press. It also helps the removal of debris from the press and assists in the maintenance of water/ink balance by minimizing the amount of water necessary to obtain a clean print. (See, The Printing Ink Manual, Fifth Edition, edited by R. H. Leach and R. J. Pearce, page 20, (1993)).

Fountain solutions typically contain over 90% by weight of water. Additional ingredients may be added to enhance the interaction of the fountain solution with the printing plate. Id. Typical ingredients include desensitizing agents (such as gum Arabic or carboxymethylcellulose), buffering agents (such as salts or acids), surfactants, coupling agents (to keep the additional ingredients soluble in water), anti-foaming agents and biocidal agents.

Typically, fountain solutions are supplied in large totes or drums in concentrated form and are metered through pumps and diluted with water prior to application onto the printing plate. Improper functioning of these pumps can lead to printing problems. Also, the major cost of delivering a fountain solution to a printer arises from transportation and disposal of spent solution.

Therefore, there is a need for producing an easy to store and easy to prepare fountain solution that simultaneously eliminates the problems associated with prior fountain solutions.

The use of water-soluble pouches in other arts, such as the detergent art, is known. See, for example, EP 1 260 578, DE 10 100 338, WO 02/12432 and WO 01/85898. The films which make up the water-soluble pouches are also well known. See, for example, WO 01/23460. However, the use of water-soluble pouches is not believed to be known in the printing arts, especially in the area of offset lithographic printing. This was because the use of various water-soluble surfactants, acids and coupling agents in fountain solutions had a tendency to attack the packaging film and to stabilize any foam which was to form. Merely removing the water-soluble surfactant is not feasible as surfactant-free fountain solutions have high surface tension due to the inherently high surface tension of water which must be reduced in order to operate effectively on the printing press. Alternative solutions to the use of surfactants is fraught with their own perils, e.g., adding a solvent such as isopropanol achieves a reduction of surface tension and achieves good surface wetting, but isopropanol is a Volatile Organic Compound (VOC) and prolonged exposure to the atmosphere results in evaporation of the isopropanol, which not only adversely affects the properties of the fountain solution, but also is environmentally undesirable.

Finally, because of the incompatibilities between the various components of the fountain solution formulation, it has proven difficult to produce a ready-to-use, stable, concentrated fountain solution that can be packaged in a water-soluble pouch, e.g. gum Arabic is incompatible with solvents. (See, The Printing Ink Manual, supra, page 20).

### SUMMARY OF THE INVENTION

These and other objects were met with the present invention, which relates in a first embodiment to a fountain solution kit comprising:
(a) a first water-soluble pouch which contains solid materials suitable for a fountain solution; and
(b) a second water-soluble pouch which contains a liquid; and
(c) optionally, a third water-soluble pouch which contains the first and second water-soluble pouches.

### DETAILED DESCRIPTION OF THE INVENTION

The present invention reduces transportation, storage, disposal and handling costs associated with typical fountain solutions. This is achieved by creating novel concentrated fountain solutions which will not destroy the water-soluble film in which the fountain solution concentrate is contained and by creating an individual pouch system which eliminates the need for coupling agents to be present in non-concentrated fountain solutions and overcomes the problem of component incompatibility. In one preferred embodiment, the present invention relates to a co-pack arrangement which comprises two water-soluble pouches optionally enveloped by a third outer pouch. In a particularly preferred embodiment, the first water-soluble pouch contains solid materials and the second water-soluble pouch contains liquid. Such a co-pack arrangement facilitates “just-in-time” (i.e. at the moment of need) delivery of a diluted fountain solution to the printing plate at which time the first water-soluble pouch and the second water-soluble pouch are exposed to water to form a diluted press-ready fountain solution.

The water-soluble co-pack arrangement provides a convenient, safe and economical means of delivering fountain solution to a printing press. The water-soluble co-pack arrangement of the invention allows for separation of ingredients until the need arises to form the fountain solution and precludes the need for ingredients which impart stability such as coupling agents. In addition to lowered raw material costs, due to elimination of ingredients such as coupling agents, it also may eliminate little problems caused by the presence of coupling agents in fountain solutions.

Since most fountain solutions contain more than 90% by weight of water, the cost of transportation is dramatically reduced over pre-made fountain solutions as now only the water-soluble co-packs need be sold rather than bulky totes or drums containing water and the other ingredients constituting the fountain solutions.

Moreover, the water-soluble co-pack arrangement also overcomes the incompatibilities of mixing various components when trying to produce a stable concentrated fountain solution. (For example, gum Arabic, a commonly used desensitizer for fountain solutions, is normally unusable when exposed long-term to solvents such as glycols and glycol ethers. See, The Printing Ink Manual, supra, page 20.)

One preferred embodiment of the invention is a fountain solution kit comprising:
(a) a co-pack arrangement comprising:
   (1) a first water-soluble pouch which contains solid materials suitable for a fountain solution; and
   (2) a second water-soluble pouch which contains liquid materials; and
(b) optionally, a third pouch which contains the first and second water-soluble pouch and is optionally water-soluble.

The solid materials suitable for a fountain solution can preferably be a solid from the class of compounds selected from the group consisting of desensitizers, pH buffers, humectants, sequestering agents (chelating agents), biocides, corrosion inhibitors, viscosity increasing agents and mixtures of the foregoing compounds.

Suitable desensitizers useful in the context of the present invention are all those customarily used in the art. Examples of suitable desensitizers include natural materials and modified products thereof such as gum Arabic, starch derivatives (e.g., dextrin, enzyme-decomposed dextrin, hydroxypropylated enzyme-decomposed dextrin, carboxymethylated starch, phosphoric acid starch, octenyl succinated starch), alginate, and cellulose derivatives (e.g., carboxymethyl cellulose, carboxyethyl cellulose, methyl cellulose). In a preferred embodiment of the invention, the desensitizer is selected from the group consisting of: carboxymethyl cellulose and solid gum Arabic.

Suitable pH buffers useful within the context of the present invention are all those customarily used in the art. Examples of suitable pH buffers include water-soluble organic acid and/or inorganic acid or salts thereof. Examples of the organic acid include citric acid, ascorbic acid, malic acid, tartaric acid, lactic acid, acetic acid, gluconic acid, hydroxyacetic acid, oxalic acid, malonic acid, levulinic acid, sulfanilic acid, p-toluenesulfonic acid, phytic acid, and organic phosphonic acid. Examples of the inorganic acid include phosphoric acid, nitric acid, sulfuric acid, and polyphosphoric acid. Furthermore, alkali metal salts, alkaline earth metal salts, ammonium salts, and organic amine salts of these organic acids and/or inorganic acids can be preferably used. These organic acids, inorganic acids and/or salts thereof may be used alone or as mixtures of two or more. In one preferred embodiment, the pH of the fountain solution composition is preferably adjusted to a range of 3 to 7 by these compounds. In another preferred embodiment, the fountain solution composition may be used in an alkaline region of 7 to 11 by using an alkali metal hydroxide, phosphoric acid, an alkali metal salt, an alkali metal carbonate, or a silicate. In a particularly preferred embodiment of the invention, the pH buffer is selected from the group consisting of: citric acid, glycolic acid and sodium and potassium salts of these same acids.

Suitable humectants useful within the context of the present invention are any humectants customarily used in the art. Examples of suitable humectants are: bone phosphate, calcium polyphosphate, dioctyl sodium sulfosuccinate, erythritol, glycerol, maltitol, maltitol, mannitol, polydextroses, polyglycitol syrup, potassium polyphosphates, alkylene glycols, especially, propylene glycol, sodium hydrogen DL-malate, sodium lactate, sorbitol, d-tagatose, trehalose, triacetin, xylitol and mixtures thereof. In a preferred embodiment of the invention, the humectant is selected from the group consisting of: glycerol, sorbitol, and alkylene glycols.

Suitable sequestering agents (chelating agents) are likewise all those customarily used in the art. Examples of suitable chelating compounds include organic phosphonic acids and phosphonoalkanetricarboxylic acids, such as ethylenediaminetetraacetic acid, a potassium salt thereof, a sodium salt thereof; diethylenetriaminepentaacetic acid, a potassium salt thereof, a sodium salt thereof; triethylenetetraminehexaacetic acid, a potassium salt thereof, a sodium salt thereof, hydroxyethylethylenediaminetriacetic acid, a potassium salt thereof, a sodium salt thereof; nitrilotriacetic acid, a potassium salt thereof, a sodium salt thereof, 1-hydroxyethane-1,1-diphosphonic acid, a potassium salt thereof, a sodium salt thereof, and aminotri(methylenephosphonic acid), a potassium salt thereof, a sodium salt thereof. In place of the sodium salts and potassium salts of the above chelating compounds, organic amine salts can also be effectively used. In a preferred embodiment of the invention, the sequestering agent (chelating agent) is selected from the group consisting of: ethylenediaminetetraacidic acid, and inorganic salts thereof.

Suitable biocides are all those preservatives customarily used in the art. Examples of suitable preservatives for use in the present invention include phenol or derivatives thereof, formalin, imidazole derivatives, sodium dehydroacetate, 4-isothiazolin-3-one derivatives, benzotriazole derivatives, derivatives of amidine and guanidine, quaternary ammonium salts, derivatives of pyridine, quinoline and guanidine, derivatives of diazine and triazole, derivatives of oxazole and oxazine, bromonitropropanol, 1,1-dibromo-1-nitro-2-ethanol, and 3-bromo-3-nitropentane-2,4-diol. The preferred addition amount is a sufficient amount to exhibit effects to bacteria, fungus and yeast; therefore, the amount depends on the kinds of bacteria, fungus and yeast. However, the preservatives are preferably used in an amount of 0.001 to 1.0 wt % based on the fountain solution composition. Two or more of the preservatives are preferably used in combination so as to be effective to various kinds of fungus, bacteria and yeast.

Suitable corrosion inhibitors likewise are all those customarily used in the art. Examples of suitable corrosion inhibitors include benzotriazole, 5-methylbenzotriazole, thiosalicylic acid, benzimidazole, and derivatives thereof.

Suitable viscosity increasing agents include all those customarily used in the art. Examples of suitable viscosity increasing agents include ethyl cellulose and nitrocellulose.

Additional ingredients may include perfumes, colorants and defoaming agents, and the like.

In a preferred embodiment of the invention, the solid material comprises or consists of a desensitizing agent, a chelating agent, a desensitizer and a buffer acid.

In a preferred embodiment of the invention, the composition of the solid material in percent by weight relative to the total weight of the solid material is:

| | | |
|---|---|---|
| (a) | chelating agent | about 1% to about 2.1% |
| (b) | desensitizer | about 80% to about 95% |
| (c) | buffer/acid | about 5% to about 10% |

In another preferred embodiment of the invention, the composition of the solid material in percent by weight relative to the total weight of the solid material is:

| | | |
|---|---|---|
| (a) | chelating agent | about 1% to about 2% |
| (b) | desensitizer | about 90% to about 95% |
| (c) | buffer/pH adjuster | about 5% to about 10% |

The liquid materials suitable for inclusion in the second water-soluble pouch can include glycols and glycol ethers, and surfactants. In one preferred embodiment of the invention, the ether and alcohols are selected from the group consisting of dipropylene glycol monomethyl ether, ethylene glycol, and mixtures thereof.

Suitable surfactants useful within the context of the present invention may include a nonionic surfactant selected from any used routinely in the art for ink and ink-related applications. Examples of suitable nonionic surfactants include acetylenic glycols, ethoxylated glycols, ethoxylated alkylphenols, ethoxylated alcohols, sorbitan esters, and mixtures thereof. In a preferred embodiment of the invention, the surfactant is selected from the group consisting of: acetylenic glycols (e.g. SURFYNOL® (2,4,7,9-tetramethyldec-5-yne-4,7-diol)) and ethoxylated/propoxylated acetylenic glycols.

In one particularly preferred embodiment of the invention, the solvent comprises a mixture of a glycol ether and an acetylenic glycol surfactant, such as SURFYNOL® (2,4,7,9-tetramethyldec-5-yne-4,7-diol), available from Air Products and Chemicals, Inc., Allentown, Pa.

In another preferred embodiment of the invention, the surfactants additionally have anti-foaming effects and are selected from the group consisting of SURFYNOL® 104PA (2,4,7,9-tetramethyl-5-decyne-4,7-diol in isopropyl alcohol) and SURFYNOL® 2502 (ethoxylated/propoxylated acetylenic-based surfactant.)

The weight ratio (excluding the weight of the water-soluble pouch) of solid material to liquid material is preferably about 1:1 to about 6:1, very preferably about 5:1. In another preferred embodiment of the invention the weight ratio of solid material to liquid material is about 3.4:1, very preferably about 3:1. In yet another preferred embodiment of the invention the % weight ratio of solid material to liquid material is about 42.5:15.

Optionally, the contents of the first and second water-soluble pouch can preferably be contained into a third pouch that is optionally water-soluble. Not only does this facilitate ease of movement of the first and second water-soluble pouches but provides protection against leaks in the first and second pouches. Although the third pouch is preferably water-soluble as this facilitates direct transfer into water, the third pouch may be non-water-soluble in order to protect the pouches against premature dissolution when exposed to water.

The film for the water-soluble pouches can preferably be selected from the group consisting of polyvinyl alcohol, carboxyl group-modified polyvinyl alcohol, (“Application and Market of Water-Soluble Polymer” pp. 266-277, CMC, issued in 1984), a hydrolyzate of a copolymer of an alkyl ester and a vinyl ester (Japanese Unexamined Patent Application (Kokai) 62-179550), a PVA containing at least one of an oxyalkylene group, a sulfonic group, and a cationic group (Japanese Unexamined Patent Application (Kokai) 63-168437), a PVA containing a 2-pyrrolidone ring (Japanese Unexamined Patent Application (Kokai) 2-124945, U.S. Pat. No. 5,102,950 and EP0354410), a hydrolyzate of a copolymer of N-vinylacetamides and a vinyl ester (Japanese Unexamined Patent Application (Kokai) 5-59113), a hydrolyzate of a copolymer of a diacetone acrylamide and a vinyl ester (Japanese Unexamined Patent Application (Kokai) 5-17597), a hydrolyzate of a copolymer of an oxyalkylene group-containing vinyl ether and a vinyl ester (Japanese Unexamined Patent Application (Kokai) 11-236419), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum.

In another preferred embodiment, the film for the water-soluble pouches can be selected from the group consisting of polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohols, polyvinyl alcohol copolymers and hydroxypropyl methyl cellulose (HPMC), and mixtures thereof.

In another preferred embodiment, the film for the water-soluble pouches can be selected from a group of polymer mixtures. For example, it may be preferred that a mixture of polymers is present in the material of the compartment, whereby one polymer material has a higher water-solubility than another polymer material, and/or one polymer material has a higher mechanical strength than another polymer material. It may be preferred that a mixture of polymers is used, having different weight average molecular weights.

In another preferred embodiment, the film for the water-soluble pouches can be selected from a group of polymer blend compositions, for example, comprising hydrolytically degradable and water-soluble polymer blend such as polylactide and polyvinyl alcohol, achieved by the mixing of polylactide and polyvinyl alcohol.

In a particularly preferred embodiment of the invention, the film is polyvinyl alcohol film.

Another preferred embodiment of the invention is the preparation of a fountain solution free of stabilizing agents (coupling agents) by exposing the above described co-pack arrangement to water. In a preferred embodiment of the invention the % weight ratio of water to co-pack arrangement is about 9:1 to about 400:1. In another preferred embodiment of the invention the % weight ratio of water to co-pack arrangement is about 150:1 to about 250:1. In another particularly preferred embodiment of the invention the % weight ratio of water to co-pack arrangement is about 200:1.

The invention will now be described in greater detail with reference to the following non-limiting examples:

### EXAMPLES

### All Units are % by Weight Unless Otherwise Indicated

### Example 1

A two part formulation was developed:

Part 1 (Solids)

| | | |
|---|---|---|
| (1) | Litho gum | 26% |
| (2) | Citric acid | 20% |
| (3) | Sodium sulfate | 6% |
| (4) | Magnesium nitrate | 5% |
| (5) | Potassium hydrogen phosphate | 5% |
| (6) | Sodium tripoly phosphate | 2% |
| (7) | Sodium citrate | 4% |

Part 2 (Liquid)

| | | |
|---|---|---|
| (1) | SURFYNOL ® 104PA | 40% |
| (2) | SURFYNOL ® 2502 | 40% |
| (3) | Glycol Ether | 20% |

SURFYNOL ® 104PA (2,4,7,9-tetramethyl-5-decyne-4,7-diol in isopropyl alcohol)
SURFYNOL ® 2502 (ethoxylated/propoxylated acetylenic-based surfactant)

A co-pack was prepared containing 1.7 pounds of the solids and 0.5 pounds of the liquid in two separate water-soluble pouches formed from polyvinyl alcohol film.

The press-ready fountain solution was then run on a sheet fed press with a standard magenta ink.

The water balance range was 62-74 on the Dahlgren which is comparable to conventional fountain solutions.

It should be understood that the preceding is merely a detailed description of one preferred embodiment or a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

What is claimed is:

1. A fountain solution kit comprising:
(a) a first water-soluble pouch which contains solid materials suitable for a fountain solution; and
(b) a second water-soluble pouch which contains a liquid; and
(c) optionally, a third water-soluble pouch which contains the first and second water-soluble pouches.

2. The fountain solution kit of claim 1, wherein:
(a) the solid materials are selected from the group consisting of film-forming agents, desensitizers, buffers or pH adjusters, humectants, sequestering agents (chelating agents), biocides, corrosion inhibitors, hydrated magnesium sulphates (Epsom salts), viscosity increasing agents, and mixtures thereof; and
(b) the liquid comprises a glycol ether and/or an acetylenic glycol surfactant.

3. The fountain solution kit of claim 2, wherein:
(a) the solid materials are selected from the group consisting of film-forming agents, desensitizers, buffers or pH adjusters, sequestering agents (chelating agents), viscosity increasing agents, and mixtures thereof; and
(b) the liquid comprises a glycol ether and/or an acetylenic glycol surfactant.

4. The fountain solution kit of claim 3, wherein:
(a) the solid materials are selected from the group consisting of gum Arabic, citric acid, sodium sulfate, magnesium nitrate, potassium hydrogen phosphate, sodium tripoly-phosphate and sodium citrate; and
(b) the liquid is selected from the group consisting of 2,4,7,9-tetramethyl-5-decyne-4,7-diol in isopropyl alcohol, ethoxylated/propoxylated acetylenic-based surfactant, and mixtures thereof.

5. The fountain solution kit of claim 1, wherein the weight ratio of the solid material to liquid material, both materials excluding the weight of the water-soluble pouches, is about 1:1 to about 6:1.

6. The fountain solution kit of claim 1, wherein the weight ratio of the solid material to liquid material, both materials excluding the weight of the water-soluble pouches, is about 3.4:1.

7. The fountain solution kit of claim 4, wherein the weight ratio of the solid material to liquid material, both materials excluding the weight of the water-soluble pouches, is about 1:1 to about 6:1.

8. The fountain solution kit of claim 4, wherein the weight ratio of the solid material to liquid material, both materials excluding the weight of the water-soluble pouches, is about 3.4:1.

9. A method of preparing a fountain solution which is free of (stabilizing) coupling agents, said method comprising providing one or more fountain solution kits according to claim 1, and then exposing the first water-soluble pouch and second water-soluble pouch from the fountain solution kit(s) to water.

10. A fountain solution prepared by the method of claim 9.

11. A method of delivering a fountain solution to a printing press which comprises of mixing the water-soluble pouches from the fountain solution kit of claim 1 into water to form the fountain solution and transferring the fountain solution formed to the printing press.

12. The method of claim 1, wherein the weight ratio for the amount of water to the amount of solids and liquids excluding the weight of the pouches is from about 9:1 to about 400:1.

13. The method of claim 11, wherein the weight ratio for the amount of water to the amount of solids and liquids excluding the weight of the pouches is from about 150:1 to about 250:1.

14. The method of claim 11, wherein the weight ratio for the amount of water to the amount of solids and liquids excluding the weight of the pouches is about 200:1.
